(19) United States
(12) Patent Application Publication
(10) Pub. No.: US 2005/0269400 A1
(43) Pub. Date: Dec. 8, 2005

(54) Checking of the atomicity of commands executed by a microprocessor

(75) Inventor: Paul Fontaine, Winksele (BE)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignee: Proton World International N.V., Zaventem (BE)

(21) Appl. No.: 11/143,117

(22) Filed: Jun. 2, 2005

(30) Foreign Application Priority Data
Jun. 2, 2004 (FR) 04/51088

(51) Int. Cl. G06K 5/00

(52) U.S. Cl. 235/380

(57) ABSTRACT

A method and a system for checking the atomic character of at least one command executed by a microprocessor of an electronic component including at least one rewritable non-volatile memory, including: selecting a main command including at least one updating of at least one piece of data requiring several write operations in the non-volatile memory; executing this command several times; affecting each execution in one of the write operations, by selecting a different operation each time; and checking, after each affecting, the coherence of the data in the non-volatile memory with respect to at least one predetermined authorized state.

### BACKGROUND OF THE INVENTION

1. Field of the Invention

The present invention generally relates to the field of microcontrollers integrated in electronic components and, more specifically, to the checking of the atomic character of the commands or transactions (instruction series) executed by this microcontroller.

2. Discussion of the Related Art

The atomic character of a transaction means that one or several variables implemented by this transaction do not risk being provided with an undetermined state in case this transaction is interrupted. The simplest case is a variable having an initial state and a final state. The atomicity of a transaction implementing this variable then means that, even in case of an interruption of the transaction, the variable does not risk being provided in an intermediary state.

An example of application of the present invention is the field of smart cards with or without contacts equipped with a microcontroller.

FIG. 1 schematically shows a card 1 with chips 2 of the type to which the present invention applies. In the example of FIG. 1, the smart card is a card with contacts 3. However, the presence or the absence of a contact by no means modifies the present invention. In the case of a contactless smart card, contact recovery metal pads 3 are replaced or completed by an antenna of an oscillating circuit for communicating with a terminal emitting an electromagnetic field.

As illustrated in FIG. 1, a microcontroller chip 2 essentially includes a central processing unit 4 communicating, via one or several buses 5, with memories among which include, especially, a rewritable non-volatile memory (NVM) 6, for example, of type E²PROM. Chip 2 also comprises a RAM 7 for executing current calculations and a ROM 8 generally containing the programs executed by central unit 4. Eventually, central unit 4 is also connected (in this example by bus 5) to an input/output circuit 9 (I/O) which is here further connected to contacts 3. In the case of a contactless chip (electromagnetic transponder), the input/output circuit modulates a carrier and is thus connected to the oscillating circuit forming an antenna.

Of course, the smart card (more generally, the electronic component comprising the integrated microcontroller) may include other components and circuits according to the applications.

FIGS. 2A and 2B very schematically illustrate the atomic character of a command executed by a microcontroller. FIG. 2A illustrates the development of the command with no interrupt. FIG. 2B illustrates this development in the presence of an interrupt. The interrupt is generally, in the case of a contactless smart card, removal of the microcontroller power supply. More generally, it is any disturbance resulting in a malfunction of the microcontroller and causing its reset.

In the example of FIG. 2A, a command implementing two variables VAR1 and VAR2 respectively having initial states Ainit and Binit and supposed to take, at the end of the execution of the command, final states Afin and Bfin, is assumed.

Variables VAR1 and VAR2 are stored in non-volatile memory 6. At the beginning of the command execution (block 10), variables VAR1 and VAR2 are in their respective initial states Ainit and Binit. Assuming that the command (block 11, COMMAND) is normally executed, the non-volatile memory contains, at the end of the execution for variables VAR1 and VAR2, their respective final states (block 12).

In the case (FIG. 2B) where an interrupt INTERRUPT occurs during execution of command 11, for example, by the removal of the smart card power supply, a specific procedure is then implemented.

This procedure consists, on reset (block 13, RESET) due to the powering back on of the card, in a recovery of the atomicity (block 14, ATOMICITY RECOVERY) of the transaction. This procedure results in this example in finding back, in the non-volatile memory, either the final states (block 12) of the variables, or their initial states (block 15).

In the above example, it is assumed that, for the considered command, the transaction is considered as being atomic, provided for the updating of variables A and B to be performed for the two variables or not at all. Accordingly, an intermediary state in which a single one of the two variables is updated is considered as an invalid or unauthorized state. It should be noted that the updating of a variable or data is performed in practice by one or several operations of writing into the non-volatile memory.

Intermediary states may, if desired, be considered as coherent or authorized. For example, assuming a transaction processing four variables A, B, C, and D distributed in two groups, a respecting of the atomic character of the transaction may consist of an updating of variables two by two. In this case, four situations are considered as being logically coherent: the four variables A, B, C, and D have their initial values (no updating); the four variables A, B, C, and D have their final values (correct updating); variables A and B have their final values and variables C and D have their initial values; and variables C and D have their final values while variables A and B have their initial values.

For the atomic character of the transaction to be respected, the states of the variables in the non-volatile memory and their combination must correspond to states considered as being logically coherent. In case of a transaction interrupt, the processor must thus be capable of restoring one of the coherent states or combinations.

There exist many techniques for recovering the atomicity of a transaction. For example, U.S. Pat. No. 6,535,997, which is incorporated herein by reference, describes a processor of execution of data transactions between an external system and a smart card in which a procedure for recovering the atomic character of the transaction is implemented.

A problem is to check the efficiency of such transaction atomicity recovery procedures.

A known technique consists of repetitively interrupting the smart card power supply at a regular interval, and of ensuring that the logically coherent states are always observed when powering back on.

A disadvantage of such a method is that, even by multiplying test operations, it brings no guarantee of reliability and is only statistical.

Further, the multiplication of test operations results in an often excessive test time. This disadvantage is further increased by the significant number of commands to be tested.

Another difficulty is that conventional test techniques require a powering off of the smart for each test and forbid a test by simulation.

### SUMMARY OF THE INVENTION

The present invention aims at enabling checking of the atomic character of transactions or commands executed by a microprocessor of an electronic component, for example, a smart card. The present invention more specifically aims at checking the efficiency of the process of recovery of state(s) considered as logically coherent implemented by the microcontroller of the electronic component.

The present invention also aims at providing a solution compatible with smart card management systems.

The present invention also aims at providing a solution which reduces or minimizes the checking time while providing a reliable result in case of a successful test.

To achieve these and other objects, the present invention provides a method for checking the atomic character of at least one command executed by a microprocessor of an electronic component comprising at least one rewritable non-volatile memory, comprising:

selecting a main command comprising at least one updating of at least one piece of data requiring several write operations in the non-volatile memory;

executing this command several times;

affecting each execution in one of the write operations, by selecting a different operation each time; and

checking, after each affecting, the coherence of the data in the non-volatile memory with respect to at least one predetermined authorized state.

According to an embodiment of the present invention, the checking step is performed at the end of an atomicity recovery process implemented by the microprocessor.

According to an embodiment of the present invention, the affected write operations are successively selected in the order of their occurrence in the command execution.

According to an embodiment of the present invention, the checking is considered as having succeeded when the command ends without having been affected.

According to an embodiment of the present invention, the checking is considered as having failed as soon as an obtained state is not an authorized state.

According to an embodiment of the present invention, the affecting of each execution comprises interrupting the command before the selected write operation.

According to an embodiment of the present invention, the affecting of each execution comprises forcing the writing of incoherent data, by the selected write operation.

According to an embodiment of the present invention, after each interrupt, the state of the data in the non-volatile memory is compared with at least one predetermined authorized state.

According to an embodiment of the present invention, the method is repeated for several different main commands, selected to be representative of the operation of the electronic component.

According to an embodiment of the present invention, the electronic component is a smart card.

The present invention also provides a system for checking the atomicity of at least one main command executed by an electronic component of smart card type.

The present invention also provides an electronic component equipped with a microcontroller comprising at least one rewritable non-volatile memory, and a set of executable instructions comprising a command of affecting of a main command comprising several write operations in the non-volatile memory, said affecting command having as a parameter at least one write rank in the main command and resulting, either in interrupting the main command before writing of the rank set by said parameter, or in forcing the writing of incoherent data on writing of the considered rank.

The foregoing objects, features, and advantages of the present invention, as well as others, will be discussed in detail in the following non-limiting description of specific embodiments in connection with the accompanying drawings.

### BRIEF DESCRIPTION OF THE DRAWINGS

FIGS. 1, 2A, and 2B, previously described, are intended to discuss the state of the art and the problem to solve; and

FIG. 3 very schematically shows, in the form of blocks, an embodiment of the method for checking the atomic character of commands executed by a microprocessor according to the present invention.

### DETAILED DESCRIPTION

The same elements have been designated with the same references in the different drawings. For clarity, only those elements and steps which are necessary to the understanding of the present invention have been shown and will be described hereafter. In particular, the commands executed by the microcontroller have not been described in detail. The present invention is compatible with any conventional command, provided that it comprises at least one instruction for updating a datum in a non-volatile memory.

A feature of the present invention is to select, in the execution by a microcontroller of a transaction, the atomicity of which is desired to be checked, interrupt times selected to be particularly critical.

The present invention originates from an analysis of the critical steps or instructions of a transaction in terms of respect of its atomic character.

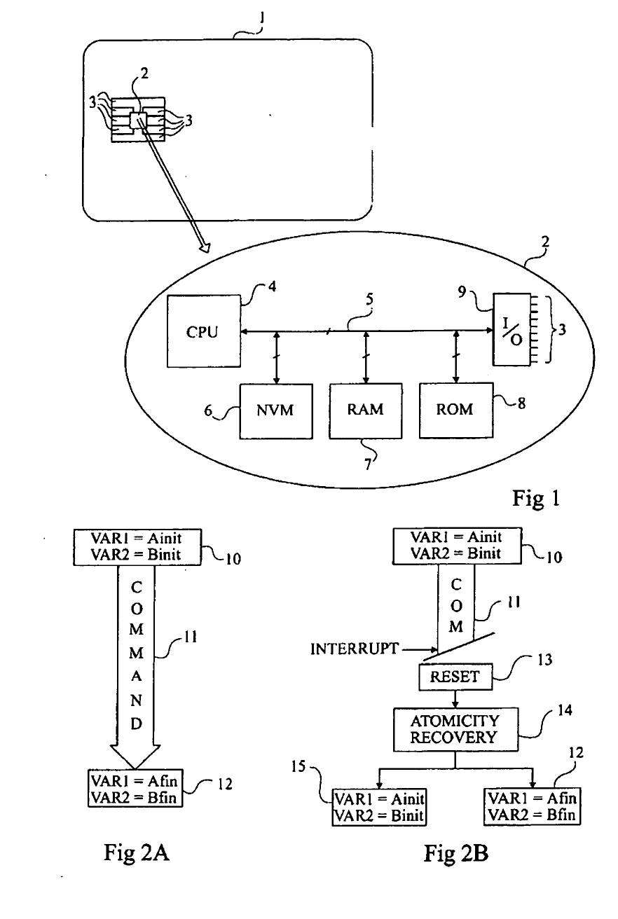

The present inventor has found that, in a microcontroller which is desired to respect a transaction atomicity criterion, the critical steps are in fact the times of writing into the non-volatile memory. Indeed, if the writing has not occurred yet, the data have not been updated and the atomicity recovery procedures will take, a priori easily, the initial value(s) of the variables. If however the data have already been updated, such atomicity recovery procedures will take, a priori easily, the final value(s). Conversely, the critical times are those where the microprocessor (central unit 4, FIG. 1) writes into the non-volatile memory.

An advantage which already appears from this specific test time selection is a considerable time gain in the test execution. Indeed, the times of writing into the non-volatile memory generally represent but a few percents of the command execution time.

According to the present invention, the test comprises executing several times the same transaction or command within which is performed at least one updating of a piece of data into the non-volatile memory associated with the microprocessor. During each execution that this command is executed, it is interrupted at a different time of its development and the state of the datum in the non-volatile memory is compared with predetermined authorized states (considered as logically coherent). The coherence of the states from the point of view of atomicity corresponds either to predetermined values, or to a logic coherence (for example, that it effectively is a date, a total monetary value, etc.).

For example, in a smart card applied to an electronic purse, a variable contained in a non-volatile memory element is the counter containing the balance of the electronic purse. In this case, the states coherent for the data formed by the counter value are the balances before and after a transaction likely to be taken by the counter.

Taking the example of the electronic purse, another variable may be concerned by the atomicity. Said variable is a transaction number which must be updated coherently with the balance. The two coherent states then are the old number-old balance and new number-new balance couples.

According to the present invention, the instruction set of the electronic component comprises a specific affecting command dedicated to the test performed by the present invention. This command comprises a command affecting a data update in the non-volatile memory. This affecting command is executed before launching a main command comprising at least one instruction for writing data into the non-volatile memory. Reference will be made hereafter to a main command to designate one or several commands manipulating one or several data of the non-volatile memory and which must generally respect an atomic character. The specific command has the function of affecting a writing either by interrupting the processing of the main command just before this writing, or by writing incoherent data at the location of the provided data. Thus, the affecting command comprises at least a parameter indicative of the number (rank) of the writing to be affected of the main command.

The present invention will be described hereafter in relation with a command interrupting the main command before a writing having its rank from the beginning of the main command identified by the parameter of the affecting command. All that will be described easily transposes to the case where incoherent data are written into the memory rather than preventing this writing. The only difference is that the affecting command then has an additional parameter containing the incoherent data to be written. As an alternative, the incoherent data are generated by the card, possibly according to the state of a parameter of the affecting command.

For simplification, the present invention will be described in relation with the writing of a piece of data, knowing that all that will be described also applies to the writing of several data, the number of which depends on the executed command.

According to a preferred embodiment, the main command is executed several times with, each time, a different rank parameter of the affecting command, the rank parameter being initialized to one, then incremented by one on each execution of the affecting command (and thus of the main command). On each interrupt, the smart card executes its conventional atomicity recovery command. The coherence of the data in the non-volatile memory is then checked. If the coherence is respected, the rank parameter is incremented and the affecting command is executed again. However, if the coherence is not respected, an error processing (conventional per se) is implemented.

In the case where the main command ends without having been interrupted, this means that the atomic character is respected for the considered main command. Indeed, this means that all write steps have been interrupted (in the preceding loops) and that it has been possible to recover coherent data.

Thus, an advantage of the present invention is that it enables validating the atomic character of the execution of a main command positively and not by default. Further, the end of the checking for a given command is automatic. In particular, it is not necessary to know in advance the number of writings implemented by this command. When the parameter of the affecting command is such that it enables for the main command to end, this means that the main command is reliable, all its writings having been tested.

A test device usable according to the present invention is any computer device capable of exchanging information with the electronic component to be tested. For example, it will be a smart card reader, equipped with a specific test program.

The present invention will be described hereafter with an example of application to smart cards. It should however be noted that it applies whatever the tested electronic component provided that it comprises a central processing unit and at least one non-volatile memory.

The checking performed by the present invention preferably is performed on a pilot product before any series production, possibly in simulation. This test may also be performed on a test smart card, for example, a smart card sampled from each manufacturing batch, provided for the affecting command to be present in the final product.

The selection of the main tested commands depends on the application for which the smart card is intended. It is desired to test commands forming cases representative of the operation of this card. For example, commands or transactions considered as representative in functional tests performed on the smart cards of the considered type may be imitated. Such tests are conventional and include checking the correct operation of the commands of a smart card.

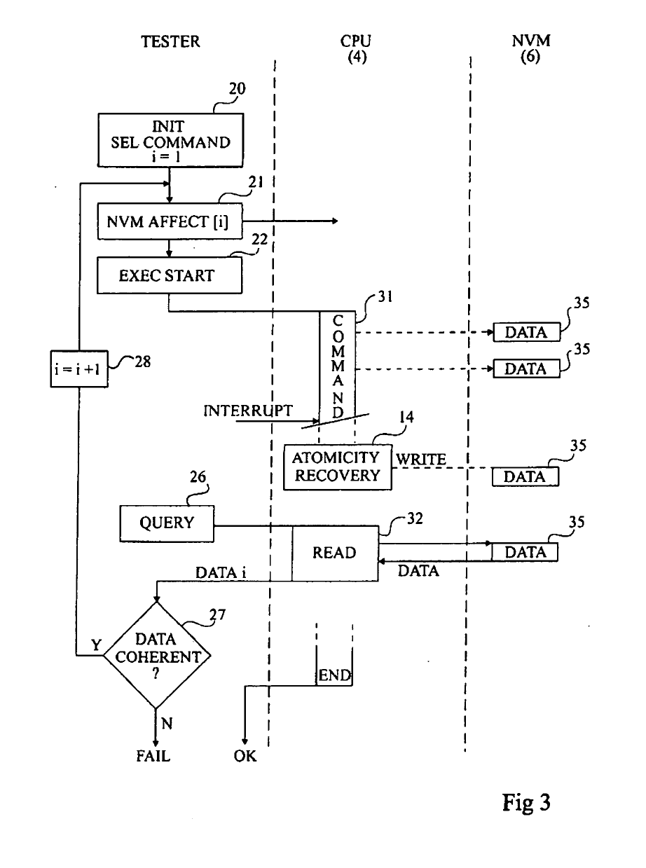

FIG. 3 illustrates, in the form of blocks, an embodiment of the checking method of the present invention. This drawing illustrates the steps implemented in an application of the method of the present invention respectively on the tester side (TESTER), on the side of the CPU 4 of the electronic component (for example, the smart card), and on the side of non-volatile memory 6 (NVM).

According to the present invention, the test method starts with an initialization step (block 20, INIT) during which the main command to be tested is selected and parameter i of the affecting command is initialized at one.

Once this initialization is over, the method of the present invention executes the affecting command (block 21, NVMAFFECT[i]) which comprises monitoring the progress of the main command to detect its write times and to be able to interrupt the execution before the writing of rank i. This command is in practice sent to central processing unit 4 so that it is able to affect the execution of the main command.

The tester then sends, to the smart card (block 22, EXEC START), an instruction for starting the execution of the considered command (block 31, COMMAND). During the command execution, writings WRITE into the NVM memory (block 35, DATA) occur at unknown times. However, as soon as rank i must occur, the card microprocessor triggers an interrupt INTERRUPT of the command.

For example, the execution of command NVMAFFECT[i] causes the initialization of a counter in the card with a value i. On each writing WRITE, central unit 4 of the card decrements this counter, then tests its current value with respect to zero. As long as the value of the counter is not zero, central unit 4 returns to the execution of the main command until and including the next write operation. As soon as the counter is at zero, central unit 4 causes interrupt INTERRUPT. As an alternative, the interrupt is replaced by the writing of incoherent data.

Since it is triggered by the card, it is a software interrupt and not a powering off. After this interrupt, the microprocessor triggers an atomicity recovery procedure. The card conventionally performs a procedure (block 14, ATOMICITY RECOVERY) of recovery of the atomicity of the command. If necessary, this procedure results in a partial or total writing (WRITE) into non-volatile memory NVM of data (block 35, DATA).

After a time interval selected to leave time to the card to end its procedure 14, the tester sends a request (block 26, QUERY) of interrogation of the variable(s), the atomicity of which must be preserved by the command execution. The time interval between blocks 25 and 26 is either set by the tester to be greater than the maximum duration of a reset with an atomicity recovery on the card side, or triggered after the card has sent to the tester a signal indicative of the end of an atomicity recovery procedure. After request 26, the card (more specifically its central unit 4) executes a read instruction (block 32, READ) of the concerned variable(s) in the NVM memory (block 35, DATA). In the example of FIG. 3, this comprises reading of block 35 which returns a value DATA.

When the tester receives datum DATA, it checks (block 27, DATA COHERENT ?) its coherence regarding the respect of the atomicity. If datum DATA is not coherent (N), the tester provides a failure indicator (FAIL) meaning that the smart card is not able to reliably recover the atomicity of the command. However, if datum DATA is coherent, the tester increments (block 28, i=i+1) rank i of the writing at which the interrupt must be triggered, and returns to block 21 of execution of the affecting command on the new rank. The steps described hereabove from step 21 are executed again with this new parameter.

The determination of the end of the test for the main ongoing command is automatic. Indeed, as soon as rank i is greater than the number of writings of this main command, there is no interrupt and the command ends (END) and results in output OK of the test program loop. The end of any command is easily detectable by a microprocessor. As soon as a test program ends by a loop exit linked to the end of the main command, the main tested command is considered as reliable regarding its atomicity.

An advantage of the present invention is that it enables checking the atomic character of a command executed by a microprocessor without it being necessary to know in advance the details of implementation of this command and especially its times of writing into the non-volatile memory.

Another advantage of the present invention is that it enables positively coming out (end of main command=reliable command) of the checking program.

Another advantage of the present invention is that it reduces or minimizes the number of tests to be performed to check the atomicity of the transactions of the smart card.

Of course, the present invention is likely to have various alterations, modifications, and improvements which will readily occur to those skilled in the art. In particular, the practical implementation of the present invention by software means is within the abilities of those skilled in the art based on the functional indications given hereabove. Similarly, the determination of the representative commands for a given application is within the abilities of those skilled in the art based on the indications given hereabove and by imitating, for example, commands considered as representative in tests functional for this application.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A method for checking the atomic character of at least one command executed by a microprocessor of an electronic component comprising at least one rewritable non-volatile memory, comprising:
selecting a main command comprising at least one updating of at least one piece of data requiring several write operations in the non-volatile memory;
executing this command several times;
affecting each execution in one of the write operations, by selecting a different operation each time; and
checking, after each affecting step, the coherence of the data in the non-volatile memory with respect to at least one predetermined authorized state.

2. The method of claim 1, wherein the checking step is performed at the end of an atomicity recovery process implemented by the microprocessor.

3. The method of claim 1, wherein the affected write operations are successively selected in the order of their occurrence in the command execution.

4. The method of claim 3, wherein the checking is considered as having succeeded when the command ends without having been affected.

5. The method of claim 1, wherein the checking is considered as having failed as soon as an obtained state is not an authorized state.

6. The method of claim 1, wherein the affecting of each execution comprises interrupting the command before the selected write operation.

7. The method of claim 1, wherein the affecting of each execution comprises forcing the writing of incoherent data, by the selected write operation.

8. The method of claim 1, wherein after each interrupt, the state of the data in the non-volatile memory is compared with at least one predetermined authorized state.

9. The method of claim 1, repeated for several different main commands, selected to be representative of the operation of the electronic component.

10. The method of claim 1, wherein the electronic component is a smart card.

11. A system for checking the atomicity of at least one command executed by an electronic component of smart card type, comprising:
means for selecting a main command comprising at least one updating of at least one piece of data requiring several write operations in the non-volatile memory;
means for executing this command several times;
means for affecting each execution in one of the write operations, by selecting a different operation each time; and
means for checking, after each affecting step, the coherence of the data in the non-volatile memory with respect to at least one predetermined authorized state.

12. An electronic component equipped with a microcontroller comprising at least one rewritable non-volatile memory, and a set of executable instructions comprising a command of affecting of a main command comprising several write operations in the non-volatile memory, said affecting command having as a parameter at least one write rank in the main command and resulting, either in interrupting the main command before writing of the rank set by said parameter, or in forcing the writing of incoherent data on writing of the considered rank.

13. The electronic component of claim 12, comprising:
means for selecting a main command comprising at least one updating of at least one piece of data requiring several write operations in the non-volatile memory;
means for executing this command several times;
means for affecting each execution in one of the write operations, by selecting a different operation each time; and
means for checking, after each affecting step, the coherence of the data in the non-volatile memory with respect to at least one predetermined authorized state.
